(19) United States
(12) Patent Application Publication
(10) Pub. No.: US 2025/0293946 A1
(43) Pub. Date: Sep. 18, 2025

(54) DISPLAY DEVICE FOR DISPLAYING MAP OF DEVICES POSITIONED AT HOME AND METHOD FOR DISPLAYING MAP THEREBY

(71) Applicant: SAMSUNG ELECTRONICS CO., LTD., Suwon-si (KR)

(72) Inventors: Eunjin LEE, Suwon-si (KR); Hyeryung KIM, Suwon-si (KR); Haeree NA, Suwon-si (KR); Haein LEE, Suwon-si (KR); Changseog KO, Suwon-si (KR); Heejin KO, Suwon-si (KR); Seungmin LEE, Suwon-si (KR)

(73) Assignee: SAMSUNG ELECTRONICS CO., LTD., Suwon-si (KR)

(21) Appl. No.: 19/225,382

(22) Filed: Jun. 2, 2025

Related U.S. Application Data
(63) Continuation of application No. PCT/KR2023/016491, filed on Oct. 23, 2023.

(30) Foreign Application Priority Data
Dec. 15, 2022 (KR) 10-2022-0176352
Feb. 7, 2023 (KR) 10-2023-0016162

(51) Int. Cl. H04L 41/22; G06F 3/0482; G06F 3/0484

(52) U.S. Cl. CPC H04L 41/22; G06F 3/0482; G06F 3/0484

(57) ABSTRACT

A display device positioned at a home where the display device comprises: a display; a communication interface; and at least one processor which receives a map corresponding to a home and device information associated with devices positioned at the home from a server via the communication interface, and controls the display to display a GUI corresponding to at least one device on the map corresponding to the home on the basis of the map and device information. The at least one processor groups multiple GUIs corresponding to multiple devices belonging to a category in each room included in the map to display a group GUI, and releases grouping corresponding to multiple devices identified on the basis of context and displays multiple GUIs corresponding to the multiple identified devices.

### CROSS-REFERENCE TO RELATED APPLICATION

This application is a continuation application is a continuation application, under 35 U.S.C. § 111(a), of international application No. PCT/KR2023/016491, filed Oct. 23, 2023, which claims priority under 35 U. S. C. § 119 to Korean Patent Application No. 10-2022-0176352, filed Dec. 15, 2022 and Korean Patent Application No. 10-2023-0016162, filed Feb. 7, 2023, the disclosures of which are incorporated herein by reference in their entireties.

### BACKGROUND OF THE INVENTION

### Field of the Invention

The disclosure relates to a display device that displays a map for devices located in a home, and a method for displaying a map thereby.

### Description of the Related Art

Various home appliances such as a TV, a refrigerator, a washing machine, an air conditioner, an oven, etc. are installed in a home.

Also, recently, a map for home appliances installed in a home is provided, and information on the devices are thereby provided visually to a user.

### DETAILED DESCRIPTION OF THE INVENTION

### Technical Solution

A display device located in a home including at least one room according to an embodiment of the disclosure includes a display, a communication interface, and at least one processor configured to receive a map corresponding to the home and information associated with devices located in the home from a server through the communication interface, and control the display to display a GUI corresponding to at least one device included on the map corresponding to the home based on the map and information associated with the at least one device, wherein the at least one processor is configured to group a first plurality of GUIs corresponding to a plurality of devices belonging to a category that is same for each room of the home included in the map and control the display to display a group GUI, and release grouping corresponding to a second plurality of devices identified according to a context and display a plurality of GUIs corresponding to the identified second plurality of devices.

Also, the at least one processor may, group the plurality of GUIs and control the display to display the group GUI based on a number of devices of the category located in a room being greater than or equal to a predetermined number, and display a GUI corresponding to the at least one device belonging to the category based on the number of the devices of the category located in the room being smaller than the predetermined number.

In addition, the at least one processor may, group the plurality of GUIs and control the display to display the group GUI based on a size of the display being smaller than a predetermined size, or the display being arranged in a vertical direction and display a group GUI, and display a GUI corresponding to at least one device belonging to the category based on the size of the display being greater than or equal to the predetermined size, and the display being arranged in a horizontal direction.

Further, the context may include at least one of a location of a user in the home, a time when the user views the map, or whether a control command for selecting a device displayed as the group GUI was received.

Also, the at least one processor may identify a plurality of devices included in a room wherein the user is located among the devices located in the home, and release grouping corresponding to the plurality of identified devices and display a plurality of GUIs corresponding to the plurality of identified devices.

In addition, the at least one processor may identify a plurality of devices belonging to a category that was controlled the most at the time when the user views the map among the devices located in the home, and release grouping corresponding to the plurality of identified devices and display a plurality of GUIs corresponding to the plurality of identified devices.

Further, the at least one processor may, based on receiving a control command for releasing grouping of the group GUI, release grouping corresponding to a plurality of devices displayed as the group GUI and display a plurality of GUIs corresponding to the plurality of devices.

Also, the at least one processor may control the display to display a GUI corresponding to some devices among the devices located in the home on the map, and based on identifying that at least one device corresponding to a context existing among the remaining devices while the GUI corresponding to some of the devices is displayed, display a GUI corresponding to the at least one identified device on the map.

In addition, the context may include at least one of whether an event occurred in a device not displayed on the map, a schedule of the user, the location of the user in the home, or whether a control command for displaying a GUI corresponding to the device not displayed on the map was received.

A method for displaying a map of a display device located in a home including at least one room according to an embodiment of the disclosure includes receiving a map corresponding to the home and information associated with devices located in the home from a server, and displaying a GUI corresponding to at least one device included on the map corresponding to the home on a display based on the map and information associated with the at least one device, and in the displaying, a first plurality of GUIs corresponding to a plurality of devices belonging to a category are grouped for each room of the home included in the map and a group GUI is displayed, and grouping corresponding to a second plurality of devices identified according to a context is released and a plurality of GUIs corresponding to the second plurality of devices identified are displayed.

In a non-transitory computer-readable medium storing computer instructions which, when executed by at least one processor of a display device located in a home including at least one room according to an embodiment of the disclosure, cause the display device to perform operations, the operations include receiving a map corresponding to the home and information associated with devices located in the home from a server, and displaying a GUI corresponding to at least one device included on the map corresponding to the home on a display based on the map and information associated with the at least one device, and in the displaying, a plurality of GUIs corresponding to a plurality of devices belonging to a category are grouped for each room of the home included in the map and a group GUI is displayed, and grouping corresponding to a second plurality of devices identified according to a context is released and a plurality of GUIs corresponding to the second plurality of devices identified are displayed.

### BRIEF DESCRIPTION OF THE DRAWINGS

FIG. 1 is a diagram for illustrating devices located in a home according to an embodiment of the disclosure;

FIG. 2 is a block diagram for illustrating a configuration of a display device according to an embodiment of the disclosure;

FIG. 3, 4A-4E, 5, 6A, 6B, 7A, 7B, 8, 9A, 9B, 10A, 10B, 11, 12A-D, 13A, and FIG. 13B are diagrams for illustrating a method for a display device to display a map according to an embodiment of the disclosure;

FIG. 14 is a block diagram for illustrating an implementation example of a display device according to an embodiment of the disclosure; and

FIG. 15 is a flow chart for illustrating a method for displaying a map according to an embodiment of the disclosure.

### MODE FOR IMPLEMENTING THE INVENTION

The various embodiments of the disclosure and the terms used in the embodiments are not intended to limit the technical characteristics described in the disclosure to specific embodiments, but they should be interpreted to include various modifications, equivalents, or alternatives of the embodiments.

Also, with respect to the detailed description of the drawings, similar or related components may be designated by similar reference numerals.

In addition, a singular form of a noun corresponding to an item may include the one item or a plurality of the items, unless instructed obviously differently in the related context.

Further, in the disclosure, each of the phrases such as “A or B,” “at least one of A and B,” “at least one of A or B,” “A, B or C,” “at least one of A, B and C,” and “at least one of A, B, or C” may include any one of the items listed together with the phrase among the above phrases, or all possible combinations thereof. For example, “A or B,” “at least one of A and B,” or “at least one of A or B” may refer to all of the following cases: (1) including at least one A, (2) including at least one B, or (3) including at least one A and at least one B.

Also, terms such as “first,” “second,” and the like may be used just to simply distinguish a component from another component, and are not intended to limit a component in another aspect (e.g.: importance or order).

Meanwhile, in case it is mentioned that a component (e.g.: a first component) is “coupled” or “connected” with another component (e.g.: a second component) together with terms such as “functionally” and “communicatively” or without such terms, it means that the component may be connected with the another component directly (e.g.: in a wired manner), wirelessly, or through a third component.

Also, terms such as “include” and “have” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in case it is mentioned that one element is “connected with,” “combined with,” “supported by,” or “contacted with” another element not only includes a case wherein the elements are directly connected, combined, supported, or contacted, but also a case wherein the elements are indirectly connected, combined, supported, or contacted through a third element.

Further, the description in the disclosure that one element is “on top of” another clement not only includes a case wherein the one element contacts the another element, but also a case wherein still another element exists between the two elements.

Also, the term “and/or” includes a combination of a plurality of related elements described, or any one element among the plurality of related elements described.

Meanwhile, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Also, in the embodiments of the disclosure, “a module” or “a part” may perform at least one function or operation, and may be implemented as hardware or software, or as a combination of hardware and software. In addition, a plurality of “modules” or “parts” may be integrated into at least one module and implemented as at least one processor (not shown), excluding “a module” or “a part” that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, an embodiment of the disclosure will be described in more detail with reference to the accompanying drawings.

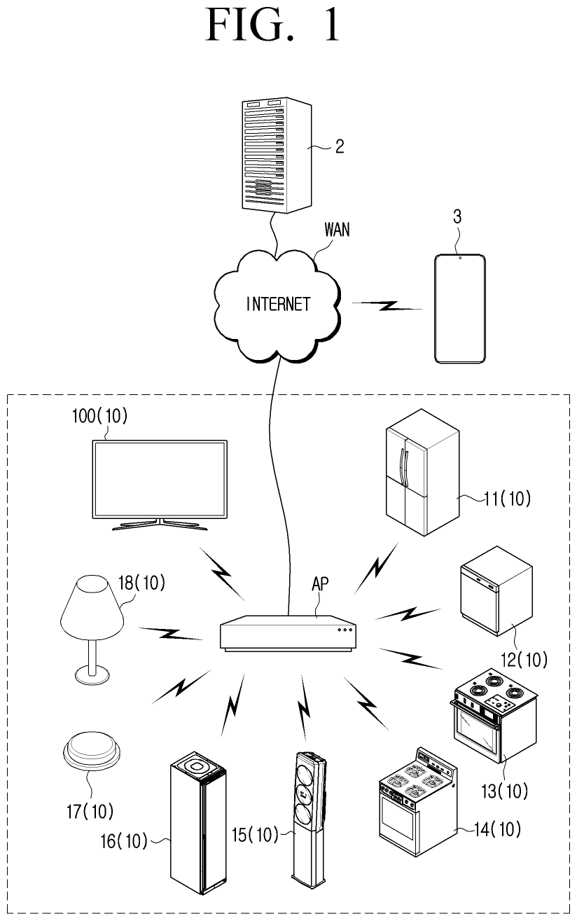

FIG. 1 is a diagram for illustrating devices located in a home according to an embodiment of the disclosure.

Referring to FIG. 1, a device 10 may include a communication interface that can communicate with a server 2, a user device 3, or another device located in a home, a user interface that receives a user input or outputs information to the user, at least one processor that controls operations of the device 10, and at least one memory that stores a program for controlling the operations of the device 10.

The device 10 may be a device located in a home. The device 10 may include various types of home appliances. For example, the device 10 may include at least one of a refrigerator 11, a dishwasher 12, an electric stove 13, an oven 14, an air conditioner 15, a clothing management device 16, a sensor 17, a lighting device 18, or a display device 100 (e.g.: a TV), as illustrated in FIG. 1. The sensor 17 may include various types of sensors that can detect an operation or a situation of a subject for detection such as a camera, a temperature sensor, a humidity sensor, a door sensor (e.g.: a door for detecting opening or closing of a door located in a home), a window sensor (e.g.: a door for detecting opening or closing of a window located in a home), a motion detection sensor, a smoke detection sensor, etc. However, the devices mentioned above are merely an example, and the device 10 may include, for example, various types of home appliances such as a cleaning robot, a vacuum cleaner, a washing machine, a dryer, a microwave oven, etc. not illustrated in FIG. 1. Also, other than the home appliances mentioned above, a device that can be connected with the server 2, the user device 3, or another device and perform operations that will be described below may be included in the device 10 according to an embodiment.

The server 2 may include a communication interface that can communicate with another server, the device 10, or the user device 3, at least one processor that can process data received from another server, the device 10, or the user device 3, and at least one memory that can store a program for processing data or store the processed data.

The server 2 may be implemented as various computing devices such as a workstation, a cloud, a data drive, a data station, etc. The server 2 may be implemented as at least one server that is physically or logically divided based on a function, a detailed constitution of the function, or data, etc., and may transmit and receive data through communication between each server, and process the transmitted and received data.

The server 2 may perform functions such as managing a user account, registering the device 10 by associating it with the user account, and managing or controlling the registered device 10, etc.

For example, the user may access the server 2 through the user device 3, and generate a user account. The user account may be identified by an ID and a password set by the user. The server 2 may register the device 10 to the user account according to a designated procedure. For example, the server 2 may connect identification information of the device 10 (e.g.: a serial number or a MAC address, etc.) to the user account, and register, manage, and control the home appliance 10.

The user device 3 may include a communication interface that can communicate with the device 10 or the server 2, a user interface that receives a user input or outputs information to the user, at least one processor that controls operations of the user device 3, and at least one memory that stores a program for controlling the operations of the user device 3.

The user device 3 may be carried by the user, or arranged in the home of the user. The user device 3 may include a personal computer, a terminal, a portable telephone, a smartphone, a handheld device, a wearable device, etc., but is not limited thereto.

In the memory of the user device 3, a program for controlling the device 10, i.e., an application may be stored. The application may be sold while being installed in the user device 3, or downloaded from an external server and installed.

The user device 3 may execute the application installed in the user device 3 according to a user input, and generate a user account by accessing the server 2 through the application, and perform communication with the server 2 based on the logged-in user account and register the device 10.

For example, if the user manipulates the device 10 such that the device 10 can access the server 2 according to a procedure guided by the application installed in the user device 3, the server 2 may register the device 10 to the user account by registering the identification information of the device 10 (e.g.: the serial number or the MAC address, etc.) to the user account.

The user device 3 may generate a map corresponding to the home wherein the device 10 is located by using the application installed in the user device 3, and set the location of the device 10 on the map. For example, the user device 3 may display a basic map through the application. The basic map may be a 2D map or a 3D map, and may consist of one room. Also, the user device 3 may generate a map by correcting the basic map according to a user input. Correction of the basic map may include setting of the name of a room, addition/deletion of a room, adjustment of the size of a room, addition/deletion of a wall, setting of the location of a door/a window, etc.

When a map is generated, the user device 3 may obtain information on the location of the device 10 on the map based on a user input. For example, the user device 3 may provide an icon corresponding to the device 10 for each device 10. Also, the user device 3 may arrange the icon corresponding to the device 10 on the map according to a user input, and obtain information on the location of the device 10 on the map by using the location wherein the icon is arranged on the map.

Through such a process, the user may generate a map having the same structure as the structure of the home of the user, and designate the location of the device on the map identically to the location wherein the device 10 is arranged in the home.

The user device 3 may communicate with the server 2 based on the logged-in user account, and transmit the map and information on the location of the device 10 on the map to the server 2. The server 2 may connect the map and the information on the location of the device 10 on the map to the logged-in user account, and store it.

The user may control the device 10 by using the application installed in the user device 3. For example, if the user logs in to the user account through the application installed in the user device 3, the device 10 registered to the user account may be displayed on the user device 3. Then, if the user inputs a control command for the device 10, the control command may be transmitted to the device 10 through the server 2.

A network may include both of a wired network and a wireless network. A wired network may include a cable network or a telephone network, etc., and a wireless network may include all networks that transmit and receive signals through radio waves. A wired network and a wireless network may be connected with each other.

A network may include a wide area network (WAN) such as the Internet, etc., and a local area network (LAN) formed with an access point (AP) as the center, and a short-range wireless network not via an access point (AP). A short-range wireless network may include Bluetooth™ (IEEE 802.15.1), Zigbee (IEEE 802.15.4), Wi-Fi Direct, Near Field Communication (NFC), Z-Wave, etc., but is not limited thereto.

The access point (AP) may connect the device 10 or the user device 3 to a wide area network (WAN) to which the server 2 is connected. The device 10 or the user device 3 may be connected to the server 3 through the wide area network (WAN).

The access point (AP) may communicate with the device 10 or the user device 3 by using wireless communication such as Wi-Fi™ (IEEE 802.11), Bluetooth™ (IEEE 802.15.1), Zigbee (IEEE 802.15.4), etc., and access the wide area network (WAN) by using wired communication, but is not limited thereto.

According to various embodiments, the device 10 may be directly connected to the server 2 or the user device 3 not through the access point (AP).

Also, the device 10 may be directly connected to the server 2 or the user device 3 through a long-range wireless network or a short-range wireless network.

For example, the device 10 may be connected to the user device 3 through a short-range wireless network (e.g.: Wi-Fi Direct).

For example, the device 10 may be connected to the server 2 or the user device 3 through the wide area network (WAN) by using a long-range wireless network (e.g.: a cellular communication module).

For example, the device 10 may access the wide area network (WAN) by using wired communication, and may be connected to the server 2 or the user device 3 through the wide area network (WAN).

In case the device 10 can access the wide area network (WAN) by using wired communication, it may operate as an access point. Accordingly, the device 10 may connect another device to the wide area network (WAN) to which the server 2 is connected. Also, the another device may connect the device 10 to the wide area network (WAN) to which the server 2 is connected.

The device 10 may transmit information on an operation or a state to another device, the server 2, or the user device 3 through the network. For example, the device 10 may transmit information on an operation or a state to another device, the server 2, or the user device 3 in case a request is received from the server 2, or in case an event occurred in the device 10, or periodically or in real time. The event may include an event wherein the device 10 performs an operation according to a function of the device 10, an event wherein the state of the device 10 is changed, etc.

When information on an operation or a state is received from the device 10, the server 2 may update the information on an operation or a state of the device 10 that was stored, and transmit the updated information to the user device 3 or another device through the network. Here, update of the information may include various operations wherein the previous information is changed such as an operation of adding new information to the previous information, an operation of replacing the previous information with new information, etc.

The device 10 may operate according to a control command received from another device, the server 2, or the user device 3. For example, in case prior approval of the user was obtained such that the device 10 can operate according to a control command of the server 2 even if there was no user input, the device 10 may operate according to the control command received from the server 2. Here, the control command received from the server 2 may include a control command that the user input through another device or the user device 3 or a control command based on a predetermined condition, etc., but is not limited thereto.

The user device 3 may transmit information on the user to the device 10 or the server 2 through the communication interface. For example, the user device 3 may transmit information on the user's location, the user's health state, the user's preference, the user's schedule, etc. to the server 2. The user device 3 may transmit the information on the user to the server 2 according to prior approval of the user.

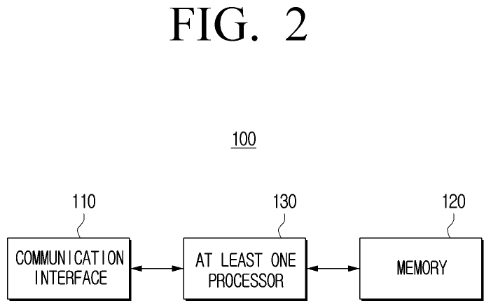

FIG. 2 is a block diagram for illustrating a configuration of a display device according to an embodiment of the disclosure.

The display device 100 may be located in a home including at least one room. The display device 100 may be implemented as a TV. For example, the display device 100 may be a light emitting diode (LED) TV, an organic light emitting diode (OLED) TV, a quantum dot light emitting diode (QLED) TV, a quantum dot TV, or a digital signage device (e.g.: an LED display module or LED display modules arranged in a matrix form). Also, the display device 100 may be a TV having a flat screen, a curved TV having a screen of a fixed curvature, or a variable curvature TV wherein the curvature can be changed.

Referring to FIG. 2, the display device 100 includes a display 110, a communication interface 120, and at least one processor 130.

The display 110 may display images. The display 110 may be implemented as various types of displays such as an LCD, LED, OLED, etc. Also, the display 110 may be implemented as a flat display, a curved display, a flexible display that can be folded and/or rolled, etc.

The communication interface 120 includes circuitry. The communication interface 120 performs communication with various external devices according to various types of communication methods. For example, the communication interface 120 may perform communication with the server 2, the user device 3, or another device located in the home, and transmit and receive various types of information or data with the device.

For this, the communication interface 120 may include a wired LAN communication module such as an Ethernet module. Also, the communication interface 120 may include a wireless communication module such as Wi-Fi, Wi-Fi Direct, Bluetooth, Bluetooth Low Energy (BLE), Zigbee, NFC, Z-wave, etc. In addition, the communication interface 120 may include a cellular communication module such as 3rd Generation (3G), 3rd Generation Partnership Project (3GPP), Long Term Evolution (LTE), 5G, etc.

The at least one processor 130 controls the display device 100 on the whole. Specifically, the at least one processor 130 may be connected with each component of the display device 100, and control the overall operations of the display device 100. For example, the at least one processor 130 may be connected with the display 110 and the communication interface 120, and control the display device 100. The at least one processor 130 may consist of one or a plurality of processors.

The at least one processor 130 may perform the operations of the display device 100 according to the various embodiments of the disclosure by executing one or more instructions stored in the memory of the display device 100.

The at least one processor 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 130 may control one or a random combination of the other components of the display device 100, and perform an operation related to communication or data processing. Also, the at least one processor 130 may execute one or more programs or instructions stored in the memory. For example, the at least one processor 130 may perform the method according to an embodiment of the disclosure by executing the one or more instructions stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 130 may be implemented as a single core processor including one core, or may be implemented as one or more multicore processors including a plurality of cores (e.g., multicores of the same kind or multicores of different kinds). In case the at least one processor 130 is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

Hereinafter, the at least one processor 130 will be referred to as the processor 130, for the convenience of explanation.

The processor 130 receives a map corresponding to the home and device information on the devices 10 located in the home from the server 2 through the communication interface 120.

For example, the processor 130 may transmit a request for a map and device information to the server 2 through the communication interface 120, and receive a map and device information from the server 2. Also, the processor 130 may receive device information from the server 2 when an event occurs in the device 10, or periodically or in real time. The event may include an event wherein the device 10 performs an operation according to a function of the device 10, an event wherein the state of the device 10 is changed, etc.

The device information may include information on the location of the device 10 on the map, information on the category of the device 10, information on an operation or a state of the device 10, identification information of the device 10, etc.

The information on the location of the device 10 on the map indicates the location of the device 10 set on the map according to the location of the device 10 in the home, and may be set by the user.

The category of the device 10 may be divided according to the type or the function of the device 10. For example, devices of the same type may belong to the same category. The type of the device 10 may be distinguished by the identification information of the device 10 (e.g.: the serial number). Also, according to functions provided by devices, devices of different types may belong to the same category. For example, devices performing a function related to safety (e.g.: a camera, a door sensor, a window sensor, a motion detection sensor, a smoke detection sensor, etc.) may belong to the same category. Also, devices performing a function of detecting a use amount of energy (e.g.: a refrigerator, a dishwasher, an electric stove, an electric oven, an air conditioner, a clothing management device, a washing machine, etc.) may belong to the same category. In addition, devices performing a function of detecting a temperature or humidity (e.g.: a temperature sensor, a humidity sensor, etc.) may belong to the same category. However, the categories mentioned above are merely an example, and the devices located in the home may be classified according to various categories other than the above. For example, devices performing a function related to air conditioning (e.g.: an air conditioner, an air purifier, a humidifier, etc.) may belong to the same category. Also, devices performing a function related to cooking (e.g.: a refrigerator, an electric stove, an oven, a microwave oven, etc.) may belong to the same category. Further, devices performing a function related to washing or drying of clothes (e.g.: a clothing management device, a washing machine, a dryer, etc.) may belong to the same category.

The information on an operation or a state may include information on a state of the device 10, a change of a state, or an operation performed in the device 10 according to a function of the device 10, etc.

The processor 130 controls the display 110 to display a graphical user interface (GUI) corresponding to at least one device on the map corresponding to the home based on the map and the device information. For example, if a control command for displaying the map is received, the processor 130 may display the map on the display 110. The control command may be received from a device for controlling the display device 100 (e.g.: a remote control or the user device 3) according to a user input that was input into the device.

Specifically, the processor 130 may display a GUI corresponding to the device 10 in the location of the device 10 on the map by using the information on the location of the device 10. The map may be a 2D map or a 3D map having the same structure as the home. Also, the GUI may include a 2D icon or a 3D icon having a shape that is identical or similar to the actual outer appearance of the device 10. As another example, the GUI may include icons in various shapes such as a sphere, a hexahedron, a circle, a quadrangle, etc. The icons may be of the same color or the same shape, or may be of different colors or different shapes for each device or for each category.

Also, if a control command for selecting the GUI displayed on the map is received, the processor 130 may display a menu item for receiving input of a user input controlling an operation of the device corresponding to the GUI. In addition, when a user input selecting a menu item is received, the processor 130 may control the communication interface 120 to transmit a control command corresponding to the received user input to the device corresponding to the GUI through the server 2. In this case, the device may operate according to the control command received through the server 2.

Also, the processor 130 may display the name of the device 10 on the map. The processor 130 may display the name of the device 10 by associating it with the GUI corresponding to the device 10. Displaying by associating the name may include displaying the name to be adjacent to the GUI or displaying the name by connecting the GUI and the name with a line, a figure, etc., such that it can be indicated that the name is the name of the device 10 corresponding to the GUI.

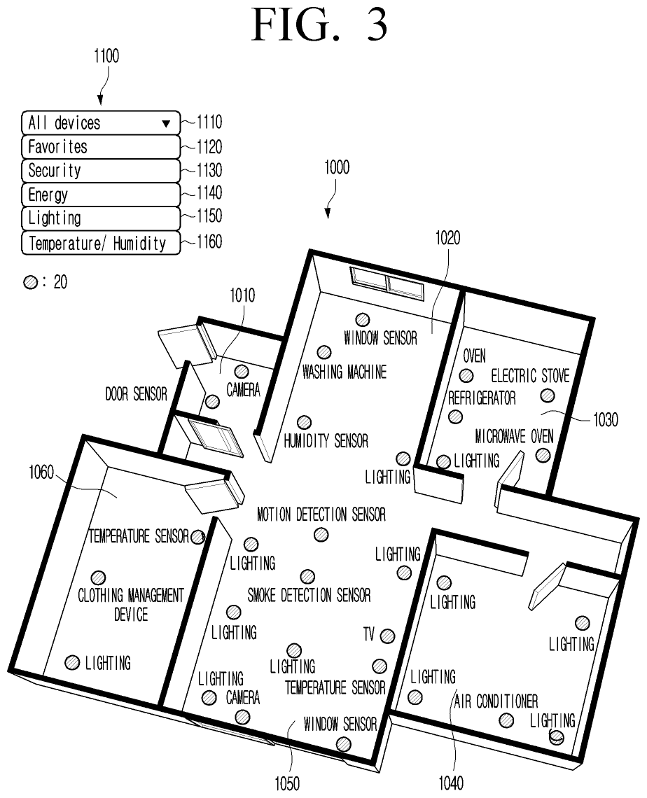

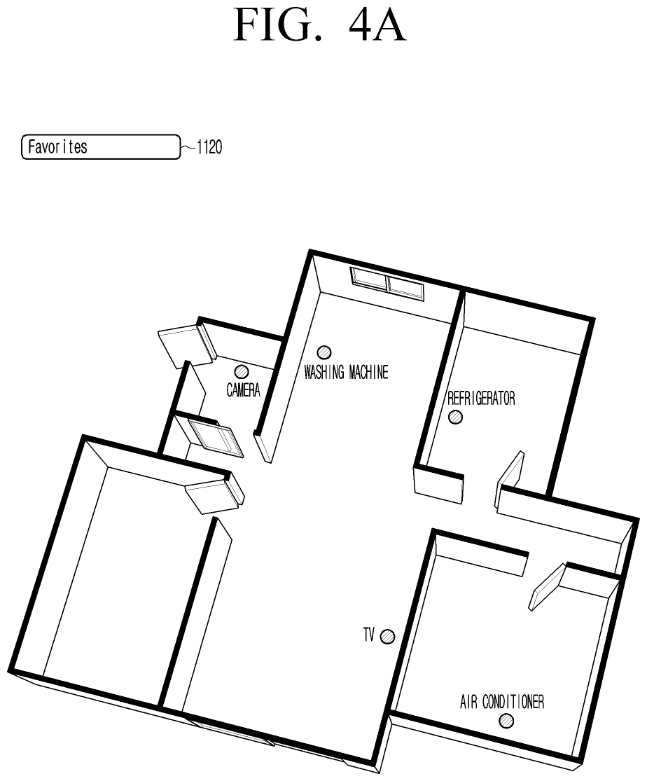

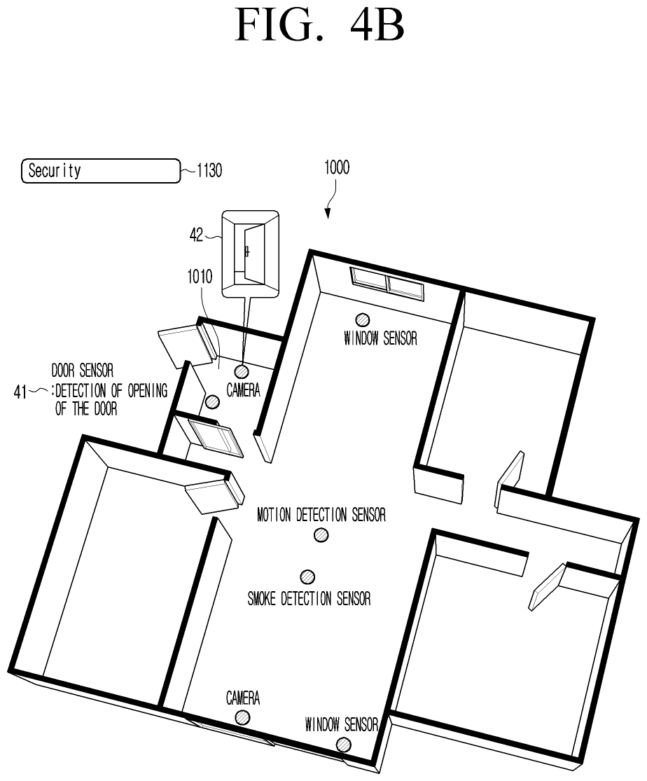

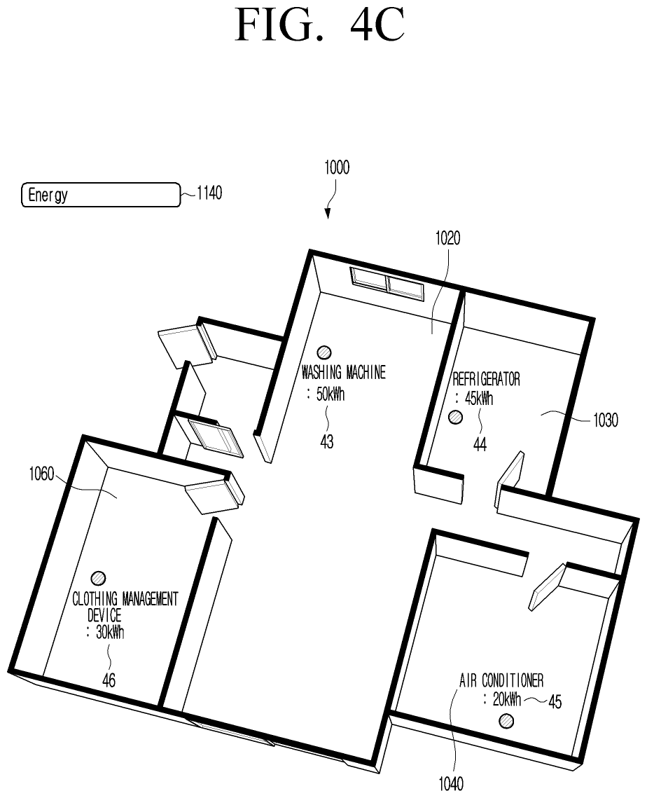

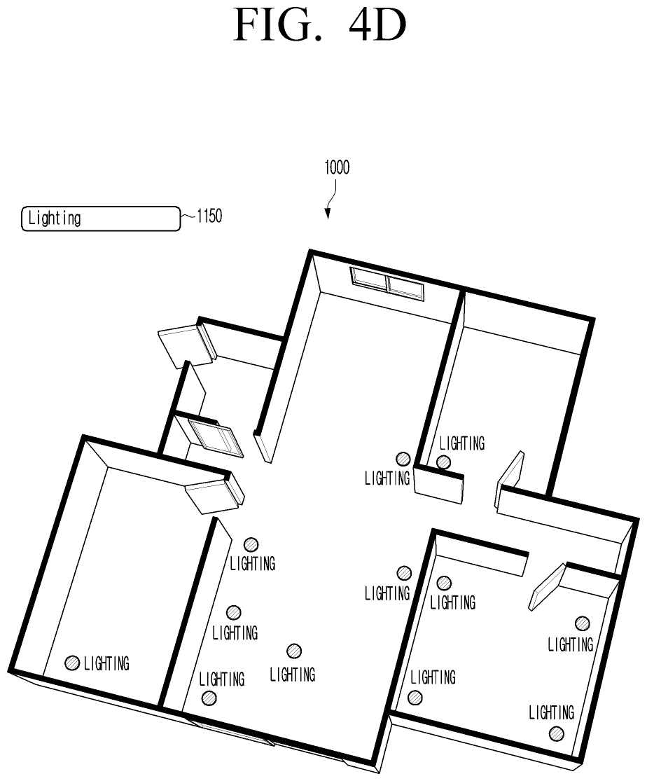

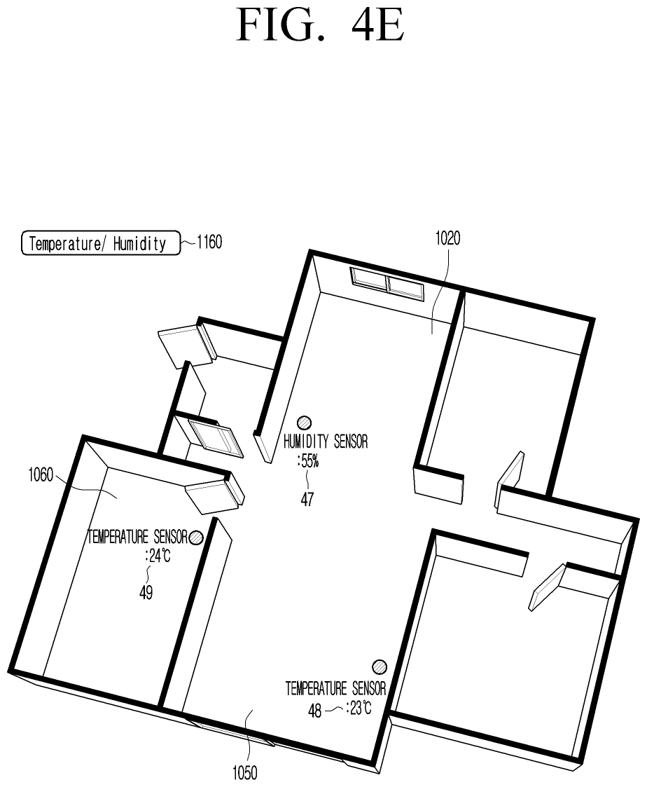

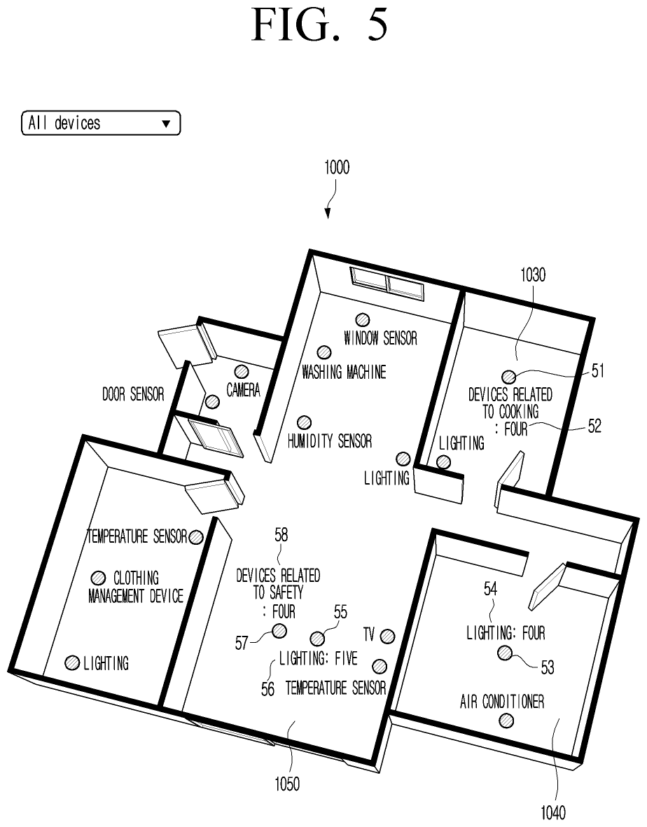

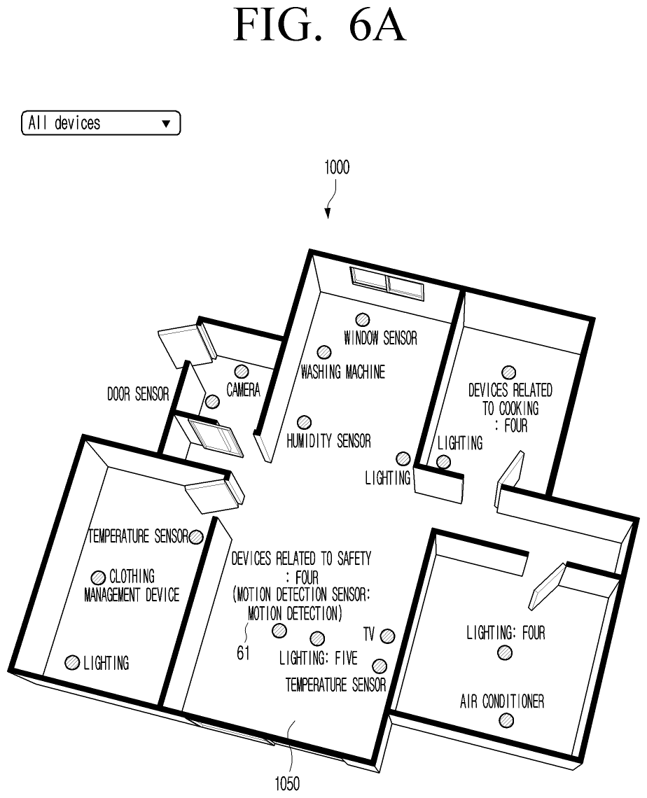

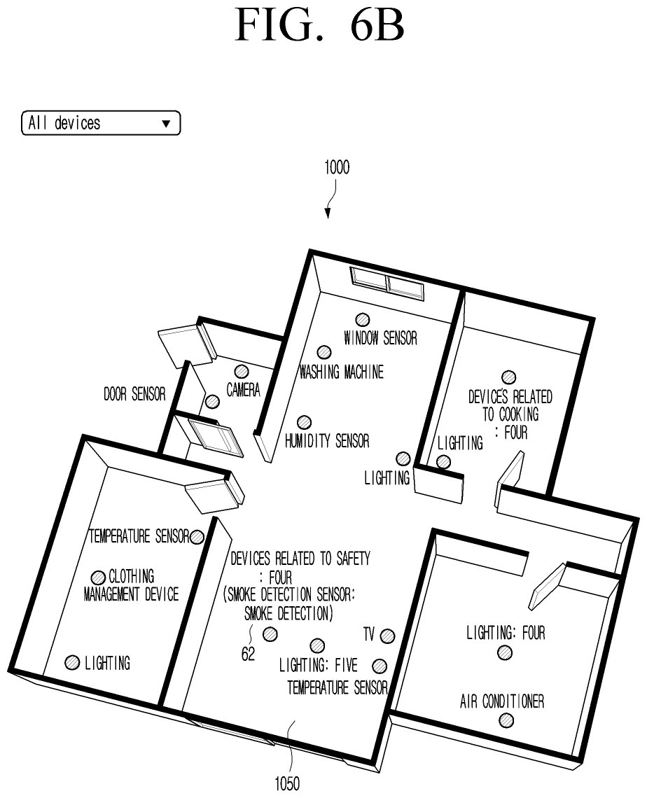

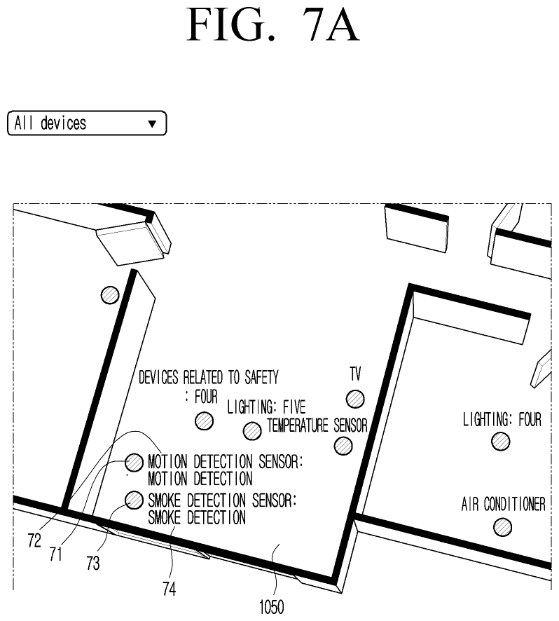

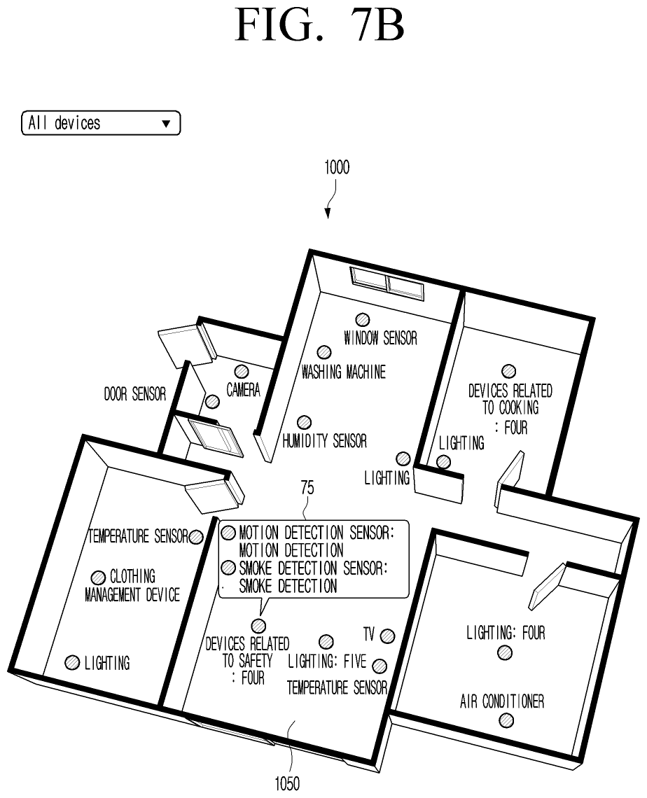

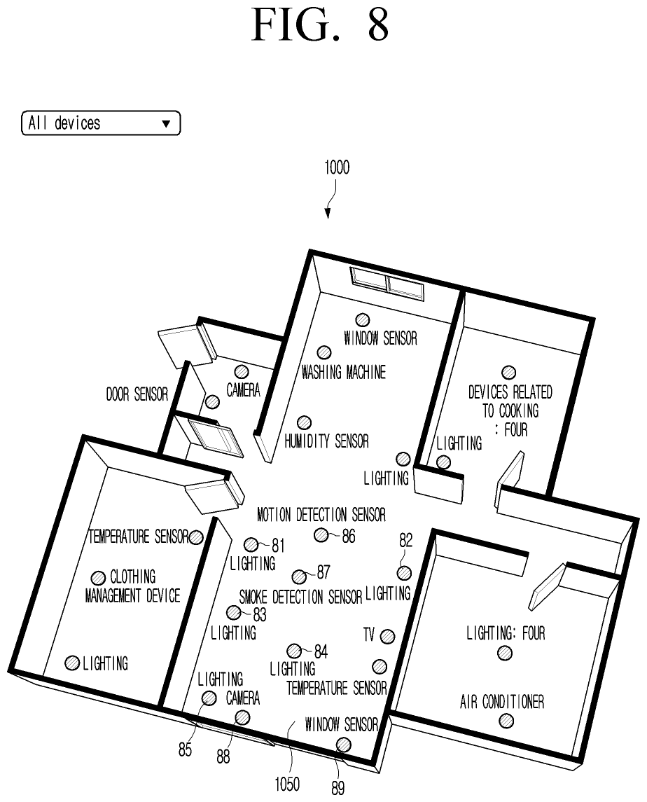

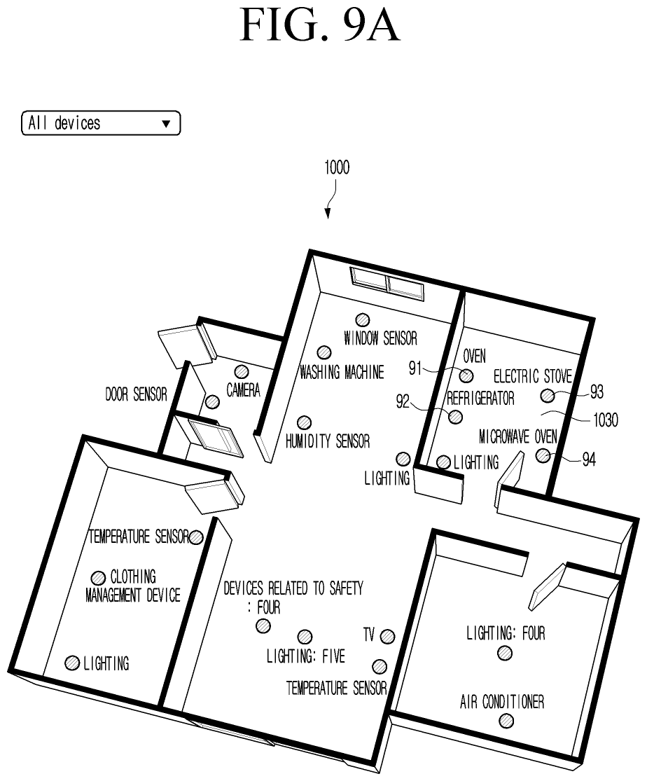

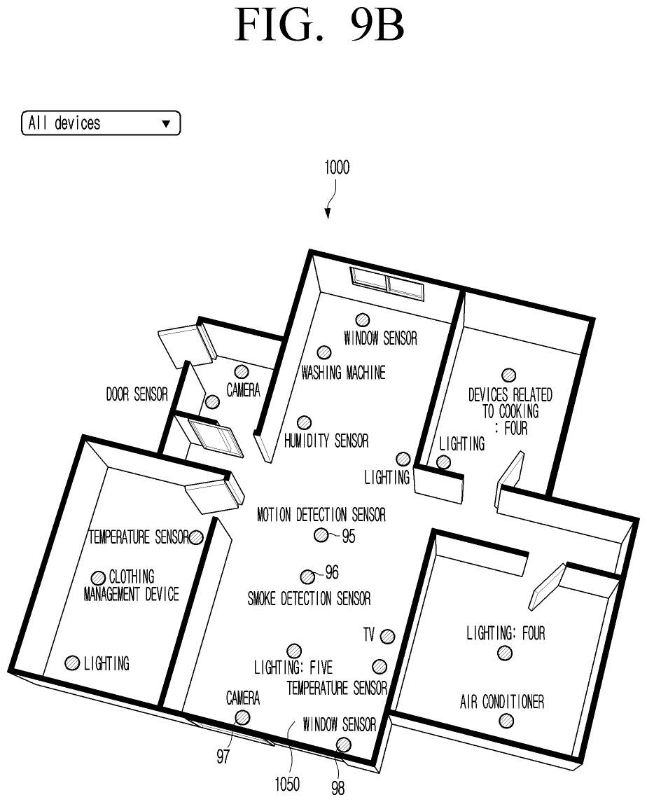

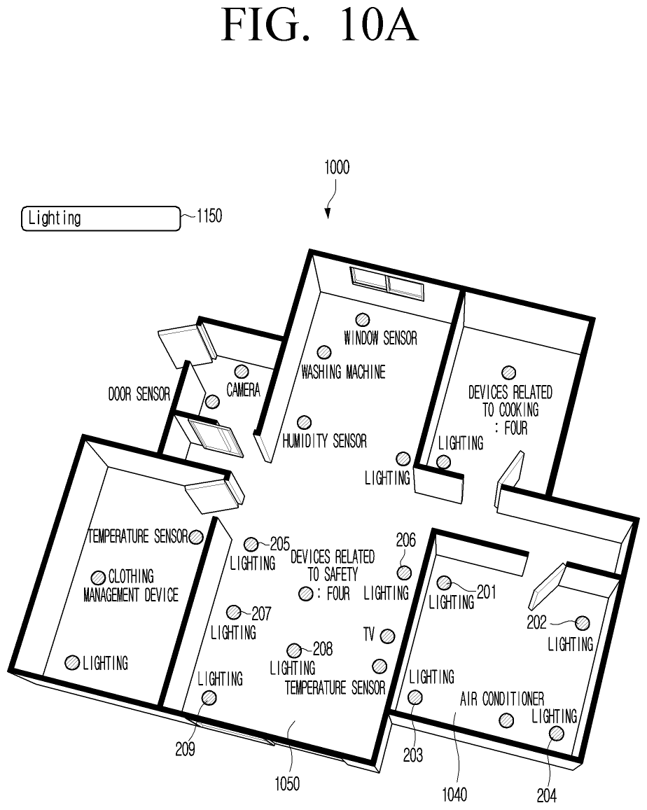

For example, as in FIG. 3, the map 1000 may be a 3D map, and may include a room 1 (e.g.: a front entrance) 1010, a room 2 1020, a room 3 (e.g.: a kitchen) 1030, a room 4 1040, a room 5 (e.g.: a living room) 1050, and a room 6 1060. On the map 1000, a plurality of GUIs 20 corresponding to the devices 10 may be displayed. Also, the names of the devices may be displayed such as “a camera,” “a door sensor,” “a window sensor,” “a motion detection sensor,” “a smoke detection sensor,” “a lighting,” “a washing machine,” “a refrigerator,” “a cleaning robot,” “an air conditioner,” “a TV,” and “a clothing management device.”

Also, the processor 130 may provide a filter function regarding the map. The filter function means a function of removing some of the plurality of GUIs 20 displayed on the map, and displaying only the GUI corresponding to the device selected by the user on the map.

For example, as in FIG. 3, the processor 130 may control the display 110 to display a filter menu 1100.

The filter menu 1100 may include menu items such as “All devices” 1110, “Favorites” 1120, “Security” 1130, “Energy” 1140, “Lighting” 1150, and “Temperature/Humidity” 1160.

“All devices” 1110 is a menu item for displaying GUIs corresponding to all devices located in the home without filtering. “Favorites” 1120 is a menu item for displaying a GUI corresponding to a device set as a bookmark by the user. “Security” 1130 is a menu item for displaying a GUI corresponding to a device performing a function related to safety. “Energy” 1140 is a menu item for displaying a GUI corresponding to a device performing a function of detecting a use amount of energy. “Lighting” 1150 is a menu item for displaying a GUI corresponding to a device performing a lighting function. “Temperature/Humidity” 1160 is a menu item for displaying a GUI corresponding to a device performing a function of detecting a temperature or humidity. However, the menu items mentioned above are merely an example, and other than such menu items, menu items that can filter the devices located in the home according to the characteristics and the functions of the devices may be included in the filter menu. For example, the filter menu may include a menu item for displaying a GUI corresponding to a device performing a function related to air conditioning, a menu item for displaying a GUI corresponding to a device performing a function related to cooking, a menu item for displaying a GUI corresponding to a device performing a function related to washing or drying of clothes, etc.

If a control command for selecting a menu item is received, the processor 130 may display only a GUI corresponding to the selected menu item among the plurality of GUIs corresponding to the devices 10 located in the home. The control command may be received from a device for controlling the display device 100 (e.g.: a remote control or the user device 3) according to a user input that was input into the device.

Also, the processor 130 may display information on an operation or a state of the device 10. The processor 130 may display information on a state of the device 10, a change of a sate, or an operation performed in the device 10 by associating the information with the GUI corresponding to the device 10. Displaying by associating the information may include displaying the information to be adjacent to the GUI or displaying the information by connecting the GUI and the information with a line, a figure, etc., such that it can be indicated that the displayed information is the information on the device 10 corresponding to the GUI.

For example, if “Favorites” 1120 is selected, as in FIG. 4A, the processor 130 may display a GUI corresponding to a device set as a bookmark by the user among the GUIs corresponding to the devices 10 on the map 1000.

For example, if “Security” 1130 is selected, as in FIG. 4B, the processor 130 may display a GUI corresponding to a device performing a function related to safety among the GUIs corresponding to the devices 10 on the map 1000. In case a door sensor located in the room 1 1010 detected opening of the door, the processor 130 may receive information indicating detection of opening of the door through the server 2, and receive an image photographed by a camera located in the room 1 1010 through the server 2. Then, the processor 130 may display the information regarding “detection of opening of the door” 41 and the received image 42.

For example, if “Energy” 1140 is selected, as in FIG. 4C, the processor 130 may display a GUI corresponding to a device performing a function of detecting a use amount of energy among the GUIs corresponding to the devices 10 on the map 1000. Then, the processor 130 may receive information on the use amounts of energy detected by each of a washing machine located in the room 2 1020, a refrigerator located in the room 3 1030, an air conditioner located in the room 4 1040, and a clothing management device located in the room 6 1060 through the server 2, and display the received information on the use amounts of energy 43, 44, 45, 46.

For example, if “Lighting” 1150 is selected, as in FIG. 4D, the processor 130 may display a GUI corresponding to a device performing a lighting function among the GUIs corresponding to the devices 10 on the map 1000.

For example, if “Temperature/Humidity” 1160 is selected, as in FIG. 4E, the processor 130 may display a GUI corresponding to a device performing a function of detecting a temperature or humidity among the GUIs corresponding to the devices 10 on the map 1000. Then, the processor 130 may receive information on the temperatures or the humidity detected by each of a humidity sensor located in the room 2 1020, a temperature sensor located in the room 5 1050, and a temperature sensor located in the room 6 1060 through the server 2, and display the received information on the temperatures and the humidity 47, 48, 49.

In the aforementioned example, it was explained that, when a menu item is selected, information received from a device is displayed on the map. However, this is merely an example, and the disclosure is not limited thereto. For example, the processor 130 may display the plurality of GUIs corresponding to the devices 10 located in the home and the information on the operations or the states of the devices 10 on the map.

Also, in the aforementioned example, it was explained that a name of a device is displayed on the map, but this is merely an example, and the disclosure is not limited thereto. For example, in case the GUIs corresponding to the devices 10 located in the home are displayed on the map, the names of the devices are not displayed, but in case a GUI corresponding to a menu item selected by the user is displayed on the map, the name of the device may be displayed.

Meanwhile, the processor 130 groups a plurality of GUIs corresponding to a plurality of devices belonging to the same category for each room included in the map, and displays a group GUI.

That is, the processor 130 may display a plurality of GUIs as one group GUI. The group GUI may have the same color or shape as the plurality of grouped GUIs. The group GUI may be displayed in a location wherein any one of the plurality of grouped GUIs is displayed in a room, or in a center area of a room.

Also, the processor 130 may display the number of the plurality of grouped GUIs on the map. For example, the processor 130 may display the number of the plurality of GUIs together with the names of the devices corresponding to the grouped GUIs.

Specifically, in case the number of the devices of the same category located in a room is greater than or equal to a predetermined number, the processor 130 may group a plurality of GUIs corresponding to the plurality of devices belonging to the same category and display a group GUI. Also, in case the number of the devices of the same category located in a room is smaller than the predetermined number, the processor 130 may display a GUI corresponding to at least one device belonging to the same category. That is, in case the number of the devices of the same category located in a room is smaller than the predetermined number, the processor 130 may display GUIs corresponding to each device without grouping.

Here, the predetermined number may be set in advance in the manufacturing stage of the display device 100, and may be changed according to a user input.

For example, a case wherein the predetermined number is four is assumed. Referring to FIG. 3, there are four devices related to cooking (e.g.: an oven, a refrigerator, an electric stove, a microwave oven) in the room 3 1030, and there are four lighting devices in the room 4 1040, and there are five lighting devices and four devices related to safety (e.g.: a camera, a window sensor, a motion detection sensor, a smoke detection sensor) in the room 5 1050.

In this case, as in FIG. 5, the processor 130 may group four GUIs corresponding to the four devices related to cooking included in the room 3 1030 and display a group GUI 51 corresponding to the four GUIs, and display information 52 on the group GUI 51. The information 52 may include the names and the number corresponding to the group GUI 51. As four devices related to cooking were grouped, the information 52 may include “devices related to cooking” and “four.”

Also, as in FIG. 5, the processor 130 may group four GUIs corresponding to the four lighting devices included in the room 4 1040 and display a group GUI 53 corresponding to the four GUIs, and display information 54 on the group GUI 53. The information 54 may include the names and the number corresponding to the group GUI 53. As four lighting devices were grouped, the information 54 may include “lighting” and “four.”

In addition, as in FIG. 5, the processor 130 may group five GUIs corresponding to the five lighting devices included in the room 5 1050 and display a group GUI 55 corresponding to the five GUIs, and display information 56 on the group GUI 55. The information 56 may include the names and the number corresponding to the group GUI 55. As five lighting devices were grouped, the information 56 may include “lighting” and “five.”

Further, as in FIG. 5, the processor 130 may group four GUIs corresponding to the four devices related to safety included in the room 5 1050 and display a group GUI 57 corresponding to the four GUIs, and display information 58 on the group GUI 57. The information 58 may include the names and the number corresponding to the group GUI 57. As four devices related to safety were grouped, the information 58 may include “devices related to safety” and “four.”

Meanwhile, the processor 130 may group a plurality of GUIs in consideration of the size and the arrangement state of the display 110. The arrangement state of the display 110 may mean whether the display 110 is arranged in a horizontal direction (e.g.: a landscape) or in a vertical direction (e.g.: a portrait).

Specifically, in case the size of the display 110 is smaller than a predetermined size, or the display 110 is arranged in a vertical direction, the processor 130 may group a plurality of GUIs corresponding to a plurality of devices belonging to the same category and display a group GUI. Also, in case the size of the display 110 is greater than or equal to the predetermined size, and the display 110 is arranged in a horizontal direction, the processor 130 may display a GUI corresponding to at least one device belonging to the same category. That is, in case the size of the display 110 is greater than or equal to the predetermined size, and the display 110 is arranged in a horizontal direction, the processor 130 may display GUIs corresponding to each device without grouping.

That is, in case the size of the display is small, the size of the map displayed on the display is also small. Also, in the case of a general display, as the width is bigger than the height, in case the display is arranged vertically, the map will be displayed to fit the width of the display, and accordingly, the size of the map displayed on the display will also be small. Meanwhile, in case a lot of devices are located in a home, if GUIs corresponding to all devices are displayed on a map of a small size, visibility for the map could deteriorate. Accordingly, in case the size of the display 110 is small, or the display 110 is arranged in a vertical direction, the processor 130 may group a plurality of GUIs corresponding to a plurality of devices and display a group GUI on the map 1000 as in FIG. 5, and in case the size of the display 110 is big, and the display 110 is arranged in a horizontal direction, the processor 130 may display the map 1000 without grouping as in FIG. 3.

Meanwhile, as the size of the display 110 is determined in the manufacturing stage of the display device 1000, it may have been determined in advance whether the size of the display 110 is greater than or equal to, or smaller than the predetermined size.

Meanwhile, the processor 130 may identify an arrangement state of the display 110 by using various methods.

For example, the processor 130 may identify an arrangement state of the display 110 according to a control command received from a device for controlling the display device 100 (e.g.: a remote control or the user device 3). Specifically, the display device 100 may include a driver (not shown) for rotating the display 110. The driver (not shown) may include a motor, an actuator, a gear, etc. If a control command for arranging the display 110 in a horizontal direction is received from the device according to a user input that was input into the device, the processor 130 may control the driver (not shown) such that the display 110 is arranged in a horizontal direction. Then, the processor 130 may identify that the display 110 is arranged in a horizontal direction. Also, if a control command for arranging the display 110 in a vertical direction is received from the device according to a user input that was input into the device, the processor 130 may control the driver (not shown) such that the display 110 is arranged in a vertical direction. Then, the processor 130 may identify that the display 110 is arranged in a vertical direction.

As another example, the processor 130 may identify an arrangement direction of the display 110 by using a sensor installed on the display 110 (e.g.: an inertial measurement unit (IMU) sensor).

Meanwhile, in the aforementioned example, it was explained that, in case the number of devices belonging to the same category in a room is greater than or equal to a predetermined number, GUIs corresponding to the devices are grouped. However, this is merely an example, and the disclosure is not limited thereto. For example, in case a plurality of devices belonging to the same category exist in a room even if their number is smaller than the predetermined number, the processor 130 may group a plurality of GUIs corresponding to the devices and display a group GUI. Also, in case the number of devices belonging to the same category on the entire map is greater than or equal to the predetermined number, the processor 130 may group a plurality of GUIs corresponding to the devices and display a group GUI. Further, in case a plurality of devices belonging to the same category exist on the entire map even if their number is smaller than the predetermined number, the processor 130 may group a plurality of GUIs corresponding to the devices and display a group GUI.

Also, in the aforementioned example, it was explained that a group GUI for a plurality of GUIs are displayed according to the size of the display 110, but this is merely an example, and the disclosure is not limited thereto. For example, in case a map is displayed in some areas of the display 110, the processor 130 may group a plurality of GUIs based on the size of the areas wherein the map is displayed and display a group GUI. Specifically, in case the size of the areas wherein the map is displayed is smaller than the predetermined size, the processor 130 may group a plurality of GUIs and display a group GUI.

In case an event occurred in at least one device among a plurality of devices corresponding to a plurality of grouped GUIs, the processor 130 may control the display 110 to display information corresponding to the event. Here, the event may include an event wherein the device 10 performs an operation, an event wherein the state of the device 10 is changed, etc. The processor 130 may receive information on an operation or a state of the device from each device wherein an event occurred through the server 2, and display the received information on the map.

Also, in case an event occurred in a plurality of devices, the processor 130 may receive information on an operation or a state of the device received from each device through the server 2, and display the received information on the map. The processor 130 may display the information during a specific time for each device, and may thereby sequentially display the information on the operations or the states of the plurality of devices.

As in the aforementioned example, the four GUIs corresponding to the four devices related to safety located in the room 5 1050 may be displayed as a group GUI. In case a motion was detected at the motion detection sensor, and smoke was detected at the smoke detection sensor among these devices, the processor 130 may receive information indicating motion detection through the server 2, and receive information indicating smoke detection through the server 2. Then, as in FIG. 6A, the processor 130 may display “Motion detection sensor: motion detection” 61 during n seconds by using the received information. Afterwards, as in FIG. 6B, the processor 130 may display “Smoke detection sensor: smoke detection” 62 during n seconds by using the received information. In this case, the processor 130 may repeatedly display the information 61 and the information 62.

If a control command for selecting a group GUI corresponding to a device wherein an event occurred is received, the processor 130 may display a GUI corresponding to the device wherein the event occurred. The control command may be received from a device for controlling the display device 100 (e.g.: a remote control or the user device 3) according to a user input that was input into the device.

For example, as in FIG. 7A, if a control command for selecting the motion detection sensor and the smoke detection sensor wherein an event occurred is received, the processor 130 may enlarge (e.g.: zoom-in) the room 5 1050 wherein the devices wherein the event occurred are located, and display a GUI 71 corresponding to the motion detection sensor, “motion detection” 71, a GUI 73 corresponding to the smoke detection sensor, and “smoke detection” 74 in the enlarged room 5 1050.

As another example, as in FIG. 7B, if a control command for selecting the motion detection sensor and the smoke detection sensor wherein an event occurred is received, the processor 130 may display a pop-up item 75 including a list for the devices wherein the event occurred. In this case, the pop-up item 75 may include a GUI corresponding to the motion detection sensor, “motion detection,” a GUI corresponding to the smoke detection sensor, and “smoke detection.”

The processor 130 may release grouping corresponding to a plurality of devices identified according to a context, and display a plurality of GUIs corresponding to the plurality of devices. That is, in case it is identified that a plurality of devices grouped as one group GUI correspond to a context, the processor 130 may release the grouping and display a plurality of GUIs corresponding to the plurality of devices on a map.

The context may include at least one of the location of the user in the home, the time when the user views the map, or whether a control command for releasing the group GUI was received.

Regarding the context, the location of the user may mean in which room the user is located in the home. The processor 130 may identify the location of the user by using various methods.

For example, in case a camera or a motion detection sensor is provided for each room, the processor 130 may receive an image photographed at the camera or a detection result of the motion detection sensor through the server 2, and identify the room wherein the user is located by analyzing the received image, or according to whether a motion was detected by the motion detection sensor.

As another example, the processor 130 may identify that a room wherein a device into which a control command was input is located is the room wherein the user is located. In case a device located in a room performed an operation, there is a high possibility that the user is located in the room. Accordingly, the processor 130 may identify a device into which a control command was input by using information on an operation or a state of the device received from the server 2, and identify that the user exists in the room wherein the device is located.

As another example, the processor 130 may identify that a room wherein the display device 100 is located is the room wherein the user is located. The feature that the user turns on the power of the display device 100, or inputs a control command into the display device 100 by using a device for controlling the display device 100 (e.g.: a remote control or the user device 3) may mean that the user is located near the display device 100. Accordingly, the processor 130 may identify that a room wherein the display device 100 is located is the room wherein the user is located.

As described above, the processor 130 may identify the location of the user in the home. Then, the processor 130 may identify a plurality of devices included in the room wherein the user is located among the devices 10 located in the home, and release grouping for the grouped devices among the plurality of devices and display a plurality of GUIs corresponding to the devices of which grouping was released.

For example, as in FIG. 8, if it is identified that the user is located in the room 5 1050, the processor 130 may release grouping for the five lighting devices and display five GUIs 81, 82, 83, 84, 85 corresponding to the five lighting devices, and release grouping for the four devices related to safety and display a GUI 86 corresponding to the motion detection sensor, a GUI 87 corresponding to the smoke detection sensor, a GUI 88 corresponding to the camera, and a GUI 89 corresponding to the window sensor.

Also, regarding the context, the time when the user views the map may mean the time when a control command for displaying the map was input into the display device 100. Accordingly, the processor 130 may identify that the time when a control command was received is the time when the user vies the map.

Then, the processor 130 may identify a plurality of devices belonging to a category that was controlled the most at the time when the user views the map among the devices located in the home, and release grouping corresponding to the plurality of devices and display a plurality of GUIs corresponding to the plurality of devices. The category that was controlled the most may be a category to which a device into which the most control commands were input at the time (or the time zone) when the user views the map during a specific period belongs. The processor 130 may analyze information on operations or states of the devices received from the server 2 during a specific period, and identify a category to which a device that performed the most operations or has the biggest number of changes of the state at the time when the user views the map belongs, and identify devices belonging to the category.

For example, a case wherein the time when the user views the map is a morning time zone, and a device related to cooking among the devices 10 located in the home performed the most operations in the morning time zone is assumed. Also, as in the aforementioned example, the four devices related to cooking located in the room 3 1030 are grouped and displayed as a group GUI. In this case, as in FIG. 9A, the processor 130 may release the grouping for the four devices related to cooking, and display a GUI 91 corresponding to an oven, a GUI 92 corresponding to a refrigerator, a GUI 93 corresponding to an electric stove, and a GUI 94 corresponding to a microwave oven.

As another example, a case wherein the time when the user views the map is a night time zone, and a device related to safety among the devices 10 located in the home performed the most operations in the night time zone is assumed. Also, as in the aforementioned example, the four devices related to safety located in the room 5 1050 are grouped and displayed as a group GUI. In this case, as in FIG. 9B, the processor 130 may release the grouping for the four devices related to safety, and display a GUI 95 corresponding to the motion detection sensor, a GUI 96 corresponding to the smoke detection sensor, a GUI 97 corresponding to the camera, and a GUI 98 corresponding to the window sensor.

Meanwhile, in the aforementioned example, it was explained that grouping is released based on a category to which a device into which the most control commands were input belongs, but this is merely an example, and the disclosure is not limited thereto.

For example, the processor 130 may identify the number of times that a control command was input into devices included in each room for each time zone during a specific period. Then, the processor 130 may identify a room into which the most control commands were input at the time when the user views the map, and release grouping for the devices included in the identified room. For example, a case wherein the time when the user views the map is a morning time zone, and the most control commands were input into the devices included in the room 4 1040 among the devices 10 located in the home is assumed. In this case, the processor 130 may release the grouping for the four grouped lighting devices in the room 4 1040, and display the four GUIs corresponding to the four lighting devices in the room 4 1040.

As another example, the time when grouping is released may be set in advance. If it is identified that the time when the user views the map matches a predetermined time, the processor 130 may release the grouping for the devices of which grouping was set to be released at the time.

Also, regarding the context, a control command for releasing a group GUI may include a control command for selecting devices displayed as the group GUI. The control command for selecting devices displayed as a group GUI may include a control command for selecting a category to which the devices displayed as the group GUI belong. The control command may be received from a device for controlling the display device 100 (e.g.: a remote control or the user device 3) according to a user input that was input into the device.

If a control command for selecting devices displayed as a group GUI is received, the processor 130 may release grouping for the plurality of devices displayed as the group GUI, and display a plurality of GUIs corresponding to the plurality of devices.

For example, as in FIG. 10A, a case wherein “Lighting” 1150 was selected among the menu items by the user is assumed. The processor 130 may release grouping for the grouped devices related to lighting on the map, and display GUIs corresponding to each device related to lighting. For example, as in FIG. 10A, the processor 130 may release grouping for the four grouped lighting devices in the room 4 1040, and display four GUIs 201, 202, 203, 204 corresponding to the four lighting devices, and release grouping for the five grouped lighting devices in the room 5 1050, and display five GUIs 205, 206, 207, 208, 209 corresponding to the five lighting devices.

Also, regarding the context, a control command for releasing a group GUI may include a control command for enlarging a room wherein the group GUI is displayed (or an area wherein the group GUI is displayed). A control command may be received from a device for controlling the display device 100 (e.g.: a remote control or the user device 3) according to a user input that was input into the device.

If a control command for enlarging a room wherein a group GUI is displayed is received, the processor 130 may release grouping for the grouped devices in the room and display GUIs corresponding to each device. For example, as in FIG. 10B, if a control command for displaying the room 4 1040 by enlarging it is received, the processor 130 may enlarge the room 4 1040. Then, the processor 130 may release grouping for the four grouped lighting devices in the room 4 1040 and display four GUIs 211, 212, 213, 214 corresponding to the four lighting devices.

The processor 130 may display GUIs corresponding to some devices among the devices 10 located in the home on the map, and if it is identified that at least one device corresponding to a context exists among the remaining devices while the GUI corresponding to some of the devices is displayed, the processor 130 may display at least one corresponding GUI on the map.

That is, the processor 130 may not display a GUI corresponding to devices belonging to a specific category on the map, but if it is identified that devices not displayed on the map correspond to a context, display a GUI for the devices on the map according to the context. The specific category may be set in advance in the manufacturing stage of the display device 100, and may be changed according to a user input. For example, regarding sensors and devices related to safety, considering their functions, there is a high possibility that the user may not use them often in usual times. Accordingly, sensors and devices related to safety may be set in advance to be not displayed on a map. However, this is merely an example, and a device having the fewest number of times that a control command was input during a specific period, or a device into which control commands were input by smaller than a predetermined number of times during a specific period among the devices 10 located in the home based on the number of times that a control command was input may be set as a device not displayed on the map.

For example, as in FIG. 11, the processor 130 may not display a GUI corresponding to sensors (e.g.: a door sensor, a window sensor, a temperature sensor, a humidity sensor) and devices related to safety (e.g.: a camera, a door sensor, a window sensor, a motion detection sensor, a smoke detection sensor) among the devices 10 located in the home on the map 1000, but display only a GUI for the remaining devices on the map 1000.

A context may include at least one of whether an event occurred in a device not displayed on the map, a schedule of the user, the location of the user in the home, or whether a control command for displaying a GUI corresponding to the device not displayed on the map was received.

First, in case an event occurred in a device not displayed on the map, the processor 130 may display a GUI corresponding to the device wherein the event occurred, and display information on an operation or a state received from the device through the server 2 on the map.

For example, in case the window sensor located in the room 2 1020 detected opening of the window, the processor 130 may receive information indicating detection of opening of the window from the window sensor located in the room 2 1020 through the server 2. In this case, as in FIG. 12A, the processor 130 may display a GUI corresponding to the window sensor that was not displayed in the room 2 1020, and display information 221 regarding “detection of opening of the window.”

Also, if a control command for displaying a GUI corresponding to a device not displayed on the map is received, the processor 130 may display the GUI corresponding to the device on the map. The control command for displaying a GUI corresponding to a device not displayed on the map may include a control command for selecting a category to which the device not displayed on the map belongs. When the control command for selecting a category to which the device not displayed on the map belongs is received, the processor 130 may display a GUI corresponding to the devices belonging to the selected category. The control command may be received from a device for controlling the display device 100 (e.g.: a remote control or the user device 3) according to a user input that was input into the device.

For example, as in FIG. 12B, a case wherein “Temperature/Humidity” 1160 among the menu items was selected by the user is assumed. In this case, the processor 130 may display a GUI corresponding to devices performing a function of detecting a temperature or humidity that were not displayed on the map 1000. That is, the processor 130 may display a GUI 222 corresponding to the humidity sensor located in the room 2 1020, a GUI 223 corresponding to the temperature sensor located in the room 5 1050, and a GUI 224 corresponding to the temperature sensor located in the room 6 1060.

The processor 130 may identify the location of the user in the home, and display a GUI corresponding to devices that are not displayed in the room wherein the user is located on the map. The method of identifying the location of the user was described above.

For example, as in FIG. 12C, if it is identified that the user is located in the room 1 1010, the processor 130 may display a GUI corresponding to devices that were not displayed in the room 1 1010. That is, the processor 130 may display a GUI 225 corresponding to the door sensor located in the room 1 1010, and a GUI 226 corresponding to the camera located in the room 1 1010.

If it is identified that a device corresponding to the user's schedule exists among the devices not displayed on the map, the processor 130 may display a GUI corresponding to the identified device on the map. The user's schedule may be obtained from schedule information registered in the user device 3 or the user account, or obtained from reservation information included in an e-mail received at the user account or a message received by the user device 3.

Specifically, the processor 130 may receive schedule information or reservation information from the user device 3 or the server 2, and analyze the received information and thereby identify whether a schedule of absence that the user will leave home because of a trip, etc. exists, and in case a schedule of absence of the user exists, identify the period of absence. Then, in case a schedule of absence of the user exists, the processor 130 may identify that devices related to safety among the devices not displayed on the map correspond to the user's schedule of absence, and display a GUI corresponding to the devices related to safety that were not displayed on the map. For example, as in FIG. 12D, the processor 130 may display a GUI corresponding to the devices related to safety that were not displayed on the map 1000. That is, the processor 130 may display GUIs 231, 232 respectively corresponding to the door sensor and the camera located in the room 1 1010, a GUI 233 corresponding to the window sensor located in the room 2 1020, and GUIs 234, 235, 236, 237 respectively corresponding to the motion detection sensor, the smoke detection sensor, the camera, and the window sensor located in the room 5 1050. In this case, the processor 130 may display a GUI corresponding to the devices related to safety during a specific period in consideration of the period of absence. The specific period is a period including the period of absence, and may include a period from a predetermined date before the starting date of the period of absence to a predetermined date after the ending date of the period of absence.

In case a new device was installed in the home, the processor 130 may display a GUI corresponding to the newly installed device on the map.

For example, the processor 130 may control the communication interface 120 to search ambient devices by using short-range wireless communication such as BLE, etc. Accordingly, if a device is found around the display device 100, the processor 130 may receive device information from the device found. Then, the processor 130 may identify that the device found is located in the same room as the display device 100, and display a GUI corresponding to the device found in the room wherein the display device 100 is located. For example, a case wherein a new air conditioner was found around the display device 100 is assumed. In this case, as in FIG. 13A, the processor 130 may display a GUI 241 corresponding to the air conditioner in the room 5 1050 wherein the display device 100 is located.

Also, in case the device found belongs to the same category as the grouped devices included in the room, the processor 130 may group the device found together with the existing devices, and display a GUI corresponding to the device found as a group GUI. In this case, the processor 130 may sum up the number of the existing devices and the number of the device found, and display the number for the group GUI. For example, a case wherein one lighting device was newly found around the display device 100 is assumed. In the room 5 1050 wherein the display device 100 is located, five lighting devices are grouped. Accordingly, as in FIG. 13B, the processor 130 may not additionally display a GUI corresponding to the lighting device found, but display the number of the group GUI corresponding to the lighting devices as six (242).

In addition, the processor 130 may receive information on devices that the other devices located in the home searched around them from the other devices located in the home through the server 2. Then, the processor 130 may display GUIs corresponding to the newly found devices in the rooms wherein each of the other devices is located by using the received information.

As described above, according to the various embodiments of the disclosure, a plurality of GUIs corresponding to devices are grouped and the plurality of GUIs are displayed as a group GUI, and the grouping is released according to various situations and the plurality of GUIs are displayed, and thus visibility for a map can be improved, and more effective interactions can be provided.

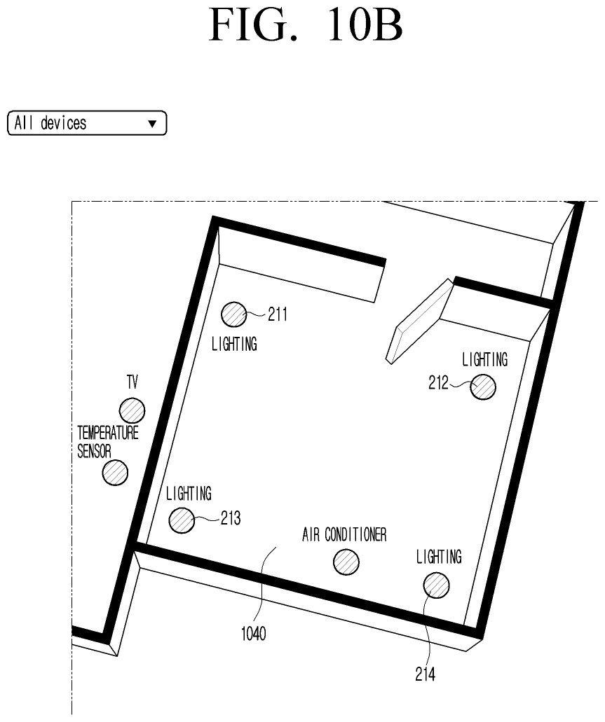

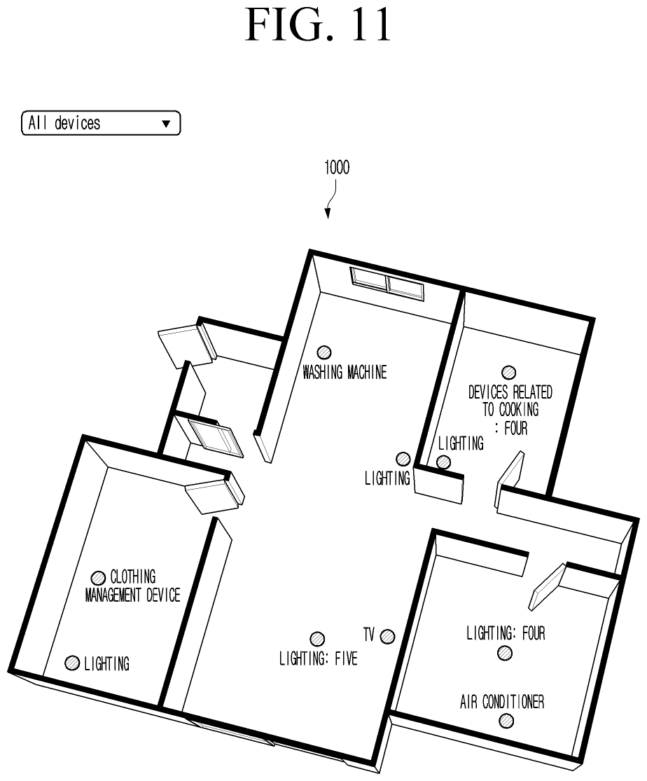

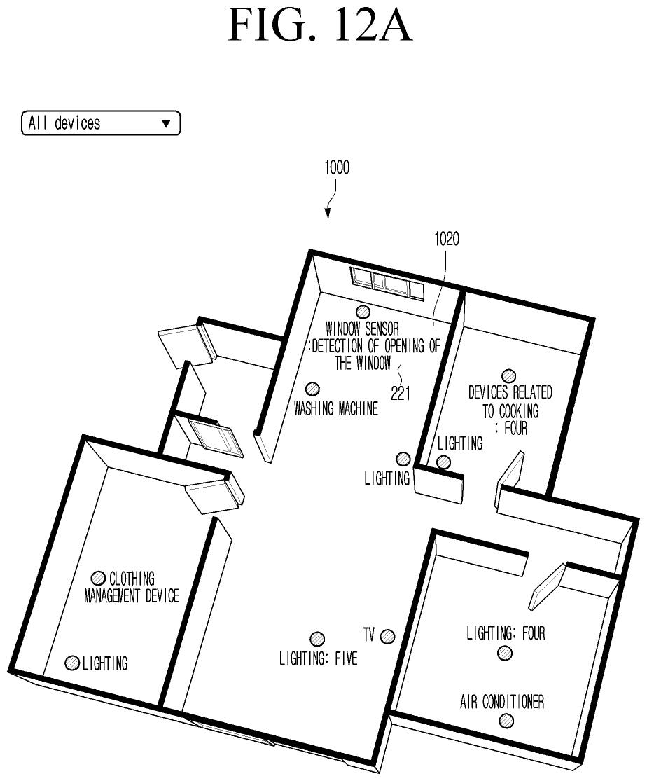

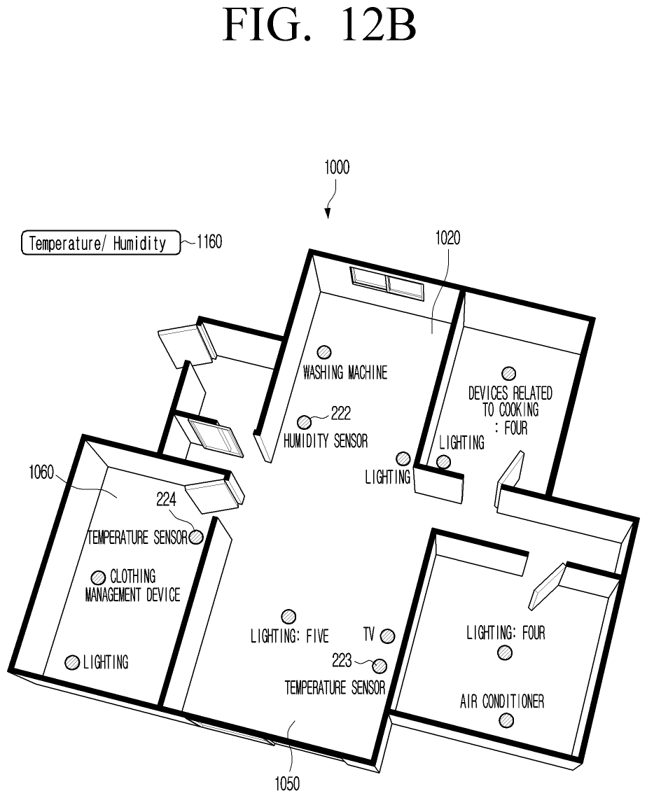

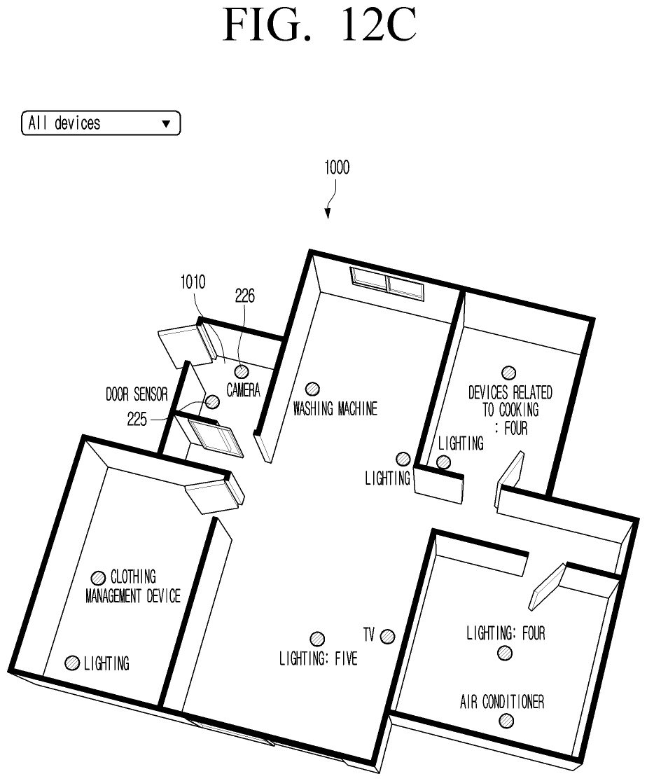

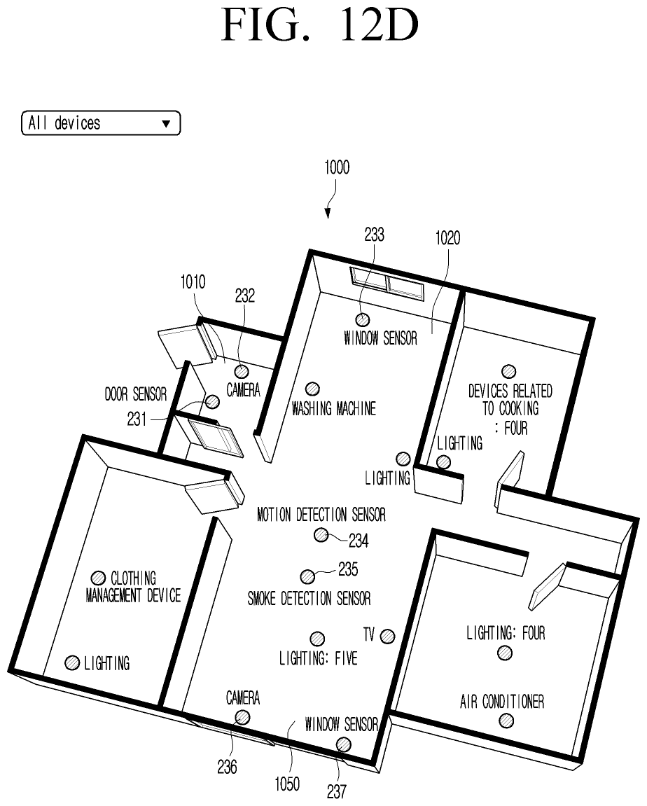

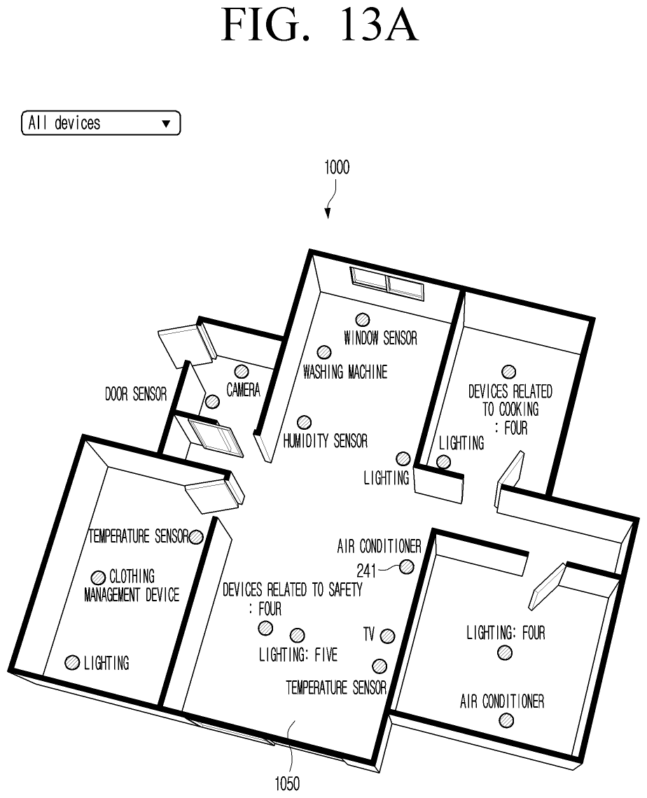

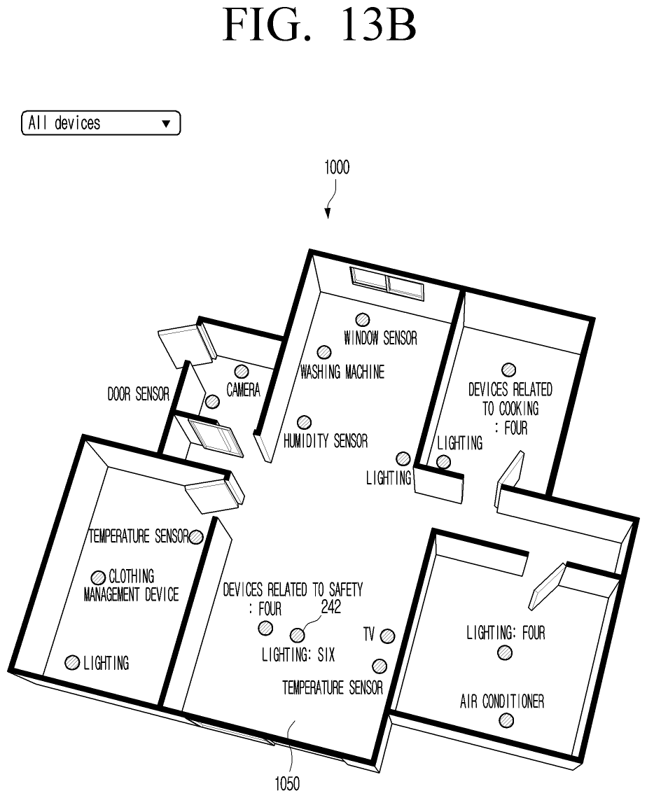

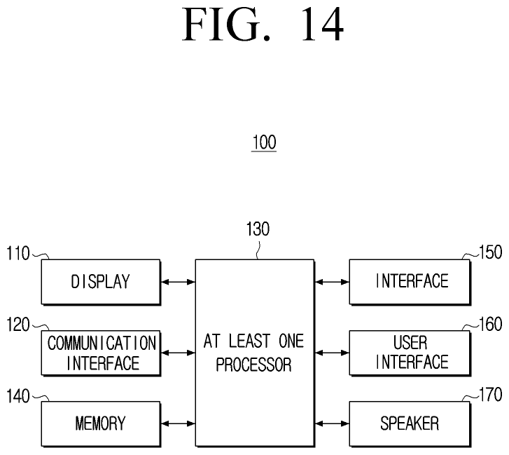

FIG. 14 is a block diagram for illustrating an implementation example of a display device according to an embodiment of the disclosure.

Referring to FIG. 14, the display device 100 may include a display 110, a communication interface 120, at least one processor 130, memory 140, an interface 150, a user interface 160, and a speaker 170. However, these components are merely exemplary ones, and it is obvious that in carrying out the disclosure, new components may be added in addition to these components or some components may be omitted. Meanwhile, among the components illustrated in FIG. 2, regarding components overlapping with the components illustrated in FIG. 14, detailed explanation will be omitted.

The memory 140 may store data necessary for the display device 100 to operate according to the various embodiments of the disclosure.

The memory 140 may be implemented as memory embedded in the display device 100 (e.g.: volatile memory, non-volatile memory, a hard drive, or a solid state drive, etc.), or implemented as memory that can be attached to or detached from the display device 100 (e.g.: a memory card, external memory, etc.) according to the use of the stored data.

Also, in the memory 140, at least one instruction may be stored. In this case, the processor 130 may perform the operations of the display device 100 according to the various embodiments of the disclosure by executing the at least one instruction stored in the memory 140. In addition, in the memory 140, programs and data for the driving of the display device 100 may be stored. Further, in the memory 140, various types of software programs and various types of applications for the display device 100 to operate may be stored.

The interface 150 may be connected with various external devices. For example, the interface 150 may be connected with external devices by using various communication methods such as a high definition multimedia interface (HDMI), a universal serial bus (USB), etc. The processor 130 may display an image on the display 110 by using data input through the interface 150, and output audio through the speaker 170.

The user interface 160 may receive input of a user input. For this, the user interface 160 may include at least one button. For example, the processor 130 may control various kinds of operations of the display device 100 based on user inputs received through the user interface 160.

Also, the user interface 160 may receive a control command from a remote control for controlling the display device 100. For example, if a button provided on the remote control is selected by the user, or a voice (e.g.: a user voice for enlarging the living room (e.g.: “Show me the living room”)) is input, the remote control may transmit a control command corresponding thereto to the display device 100. In this case, the user interface 160 may receive the control information for controlling the display device 100 from the remote control by using Bluetooth communication or infrared communication, and transmit the received control command to the processor 130. The processor 130 may control various kinds of operations of the display device 100 based on the control command.

The speaker 170 may output audio. For example, the processor 130 may convert audio received through the interface 150 or audio stored in the memory 140 into an audio signal, and output the audio signal through the speaker 150.

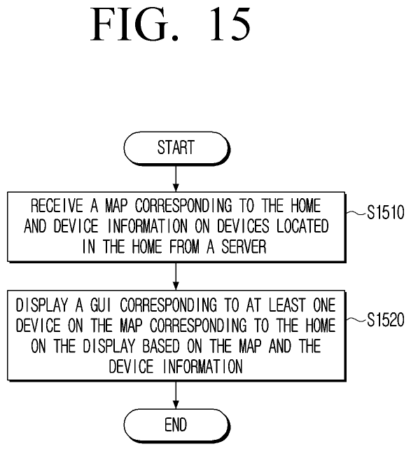

FIG. 15 is a flow chart for illustrating a method for a display device to display a map according to an embodiment of the disclosure.

The display device may be located in a home including at least one room.

First, a map corresponding to the home and device information on devices located in the home are received from a server in operation S1510.

Then, a GUI corresponding to at least one device on the map corresponding to the home is displayed on the display based on the map and the device information in operation S1520. Specifically, a plurality of GUIs corresponding to a plurality of devices belonging to the same category are grouped for each room included in the map and a group GUI is displayed, and grouping corresponding to a plurality of devices identified according to a context is released and a plurality of GUIs corresponding to the plurality of identified devices are displayed.

Also, in operation S1520, based on the number of devices of the same category located in a room being greater than or equal to a predetermined number, a plurality of GUIs corresponding to the plurality of devices belonging to the same category may be grouped and a group GUI may be displayed, and based on the number of the devices of the same category located in the room being smaller than the predetermined number, a GUI corresponding to at least one device belonging to the same category may be displayed.

In addition, in operation S1520, based on the size of the display being smaller than a predetermined size, or the display being arranged in a vertical direction, a plurality of GUIs corresponding to a plurality of devices belonging to the same category may be grouped and a group GUI may be displayed, and based on the size of the display being greater than or equal to the predetermined size, and the display being arranged in a horizontal direction, a GUI corresponding to at least one device belonging to the same category may be displayed.

Also, the context may include at least one of a location of a user in the home, the time when the user views the map, or whether a control command for selecting a device displayed as the group GUI was received.

Further, in operation S1520, a plurality of devices included in a room wherein the user is located among the devices located in the home may be identified, and grouping corresponding to the plurality of identified devices may be released and a plurality of GUIs corresponding to the plurality of identified devices may be displayed.

Also, in operation S1520, a plurality of devices belonging to a category that was controlled the most at the time when the user views the map among the devices located in the home may be identified, and grouping corresponding to the plurality of identified devices may be released and a plurality of GUIs corresponding to the plurality of identified devices may be displayed.

In addition, in operation S1520, based on receiving a control command for releasing grouping of the group GUI, grouping corresponding to a plurality of devices displayed as the group GUI may be released and a plurality of GUIs corresponding to the plurality of devices may be displayed.

Further, in operation S1520, a GUI corresponding to some devices among the devices located in the home may be displayed on the map, and based on identifying that at least one device corresponding to a context existing among the remaining devices while the GUI corresponding to some of the devices is displayed, a GUI corresponding to the at least one identified device may be displayed on the map.

Also, the context may include at least one of whether an event occurred in a device not displayed on the map, a schedule of the user, the location of the user in the home, or whether a control command for displaying a GUI corresponding to the device not displayed on the map was received.

Meanwhile, according to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the method according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or can be distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, according to an embodiment of the disclosure, the aforementioned various embodiments may be implemented in a recording medium that can be read by a computer or a device similar to a computer, by using software, hardware, or a combination thereof. In some cases, the embodiments described in this specification may be implemented as a processor itself. According to implementation by software, the embodiments such as procedures and functions described in this specification may be implemented as separate software modules. Each of the software modules can perform one or more functions and operations described in this specification.

Meanwhile, computer instructions for performing processing operations of a device according to the aforementioned various embodiments may be stored in a non-transitory computer-readable medium. Computer instructions stored in such a non-transitory computer-readable medium make the processing operations at the device according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment such as a register, a cache, and memory, etc. As specific examples of a non-transitory computer-readable medium, there may be a CD, a DVD, a hard disc, a blue-ray disc, a USB, a memory card, ROM, and the like.

Also, each of the components (e.g.: a module or a program) according to the aforementioned various embodiments may consist of a singular object or a plurality of objects. In addition, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

Also, in the above, preferred embodiments of the disclosure have been shown and described, but the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

1. A display device located in a home including at least one room comprising:
a display;
a communication interface; and
at least one processor configured to:
receive a map corresponding to the home and information associated with devices located in the home from a server through the communication interface, and
control the display to display a graphical user interface (GUI) corresponding to at least one device included on the map corresponding to the home based on the map and information associated with the at least one device,
wherein the at least one processor is configured to:
group a plurality of GUIs corresponding to a first plurality of devices belonging to a category that is same for each room of the home included in the map and control the display to display a group GUI, and release grouping corresponding to a second plurality of devices identified according to a context and display a plurality of GUIs corresponding to the second plurality of devices identified.

2. The display device of claim 1,
wherein the at least one processor is configured to:
group the plurality of GUIs and control the display to display the group GUI based on a number of devices of the category located in a room being greater than or equal to a predetermined number, and
display a GUI corresponding to the at least one device belonging to the category based on the number of the devices of the category located in the room being smaller than the predetermined number.

3. The display device of claim 1,
wherein the at least one processor is configured to:
group the plurality of GUIs and control the display to display the group GUI based on a size of the display being smaller than a predetermined size, or the display being arranged in a vertical direction, and
display a GUI corresponding to at least one device belonging to the category based on the size of the display being greater than or equal to the predetermined size, and the display being arranged in a horizontal direction.

4. The display device of claim 1,
wherein the context comprises:
at least one of a location of a user in the home, based on a time the user views the map, or whether a control command for selecting a device displayed as the group GUI was received.

5. The display device of claim 4,
wherein the at least one processor is configured to:
identify a plurality of devices included in a room of the home where the user is located among the devices located in the home, and release grouping corresponding to the plurality of identified devices and display a plurality of GUIs corresponding to the plurality of identified devices.

6. The display device of claim 4,
wherein the at least one processor is configured to:
identify a plurality of devices belonging to a category most controlled at the time the user views the map among the devices located in the home, and release grouping corresponding to the plurality of identified devices and display a plurality of GUIs corresponding to the plurality of identified devices.

7. The display device of claim 4,
wherein the at least one processor is configured to:
based on receiving a control command for releasing grouping of the group GUI, release grouping corresponding to a plurality of devices displayed as the group GUI and display a plurality of GUIs corresponding to the plurality of devices.

8. The display device of claim 1,
wherein the at least one processor is configured to:
control the display to display a GUI corresponding to some devices among the devices located in the home on the map, and based on identifying that at least one device corresponding to a context existing among a remaining devices while the GUI corresponding to some of the devices is displayed, display a GUI corresponding to the at least one identified device on the map.

9. The display device of claim 8,
wherein the context comprises:
at least one of whether an event occurred in a device not displayed on the map, a schedule of the user, the location of a user in the home, or whether a control command for displaying a GUI corresponding to the device not displayed on the map was received.

10. A method for displaying a map of a display device located in a home including at least one room, the method comprising:
receiving a map corresponding to the home and information associated with devices located in the home from a server; and
displaying a graphical user interface (GUI) corresponding to at least one device included on the map corresponding to the home on a display based on the map and information associated with the at least one device,
wherein the displaying comprises:
grouping a first plurality of GUIs corresponding to a plurality of devices belonging to a category that is same for each room of the home included in the map and displaying a group GUI, and releasing grouping corresponding to a second plurality of devices identified according to a context and displaying a plurality of GUIs corresponding to the second plurality of devices identified.

11. The method for displaying a map of claim 10,
wherein the displaying comprises:
group the plurality of GUIs and control the display to display the group GUI based on a number of devices of the category located in a room being greater than or equal to a predetermined number, and
display a GUI corresponding to the at least one device belonging to the category based on the number of the devices of the category located in the room being smaller than the predetermined number.

12. The method for displaying a map of claim 10,
wherein the displaying comprises:
grouping the plurality of GUIs corresponding to the plurality of devices belonging to the category and displaying the group GUI based on a size of the display being smaller than a predetermined size, or the display being arranged in a vertical direction, and
display a GUI corresponding to the at least one device belonging to the category based on the size of the display being greater than or equal to the predetermined size, and the display being arranged in a horizontal direction.

13. The method for displaying a map of claim 10,
wherein the context comprises:
at least one of a location of a user in the home, based on a time the user views the map, or whether a control command for selecting a device displayed as the group GUI was received.

14. The method for displaying a map of claim 13,
wherein the displaying comprises:
identifying a plurality of devices included in a room of the home where the user is located among the devices located in the home, and releasing grouping corresponding to the plurality of identified devices and displaying a plurality of GUIs corresponding to the plurality of identified devices.

15. The method for displaying a map of claim 13,
wherein the displaying comprises:
identifying a plurality of devices belonging to a category most controlled at the time the user views the map among the devices located in the home, and releasing grouping corresponding to the plurality of identified devices and displaying a plurality of GUIs corresponding to the plurality of identified devices.

16. The method for displaying a map of claim 13,
wherein the displaying comprises:
based on receiving a control command for releasing grouping of the group GUI, releasing grouping corresponding to a plurality of devices displayed as the group GUI to display a plurality of GUIs corresponding to the plurality of devices.

17. The method for displaying a map of claim 10,
wherein the displaying comprises:
displaying a GUI corresponding to some devices among the devices located in the home on the map; and
based on identifying that at least one device corresponding to a context existing among a remaining devices while the GUI corresponding to some of the devices is displayed, displaying a GUI corresponding to the at least one identified device on the map.

18. The method for displaying a map of claim 17,
wherein the context comprises:
at least one of whether an event occurred in a device not displayed on the map, a schedule of the user, the location of a user in the home, or whether a control command for displaying a GUI corresponding to the device not displayed on the map was received.

19. A non-transitory computer readable recording medium storing computer instructions that cause a display device located in a home including at least one room to perform an operation when executed by at least one processor of the display device, wherein the operation comprises;
receiving a map corresponding to the home and information associated with devices located in the home from a server; and
displaying a graphical user interface (GUI) corresponding to at least one device included on the map corresponding to the home on a display based on the map and information associated with the at least one device,
wherein the displaying comprises:
grouping a first plurality of GUIs corresponding to a plurality of devices belonging to a category that is same for each room of the home included in the map and displaying a group GUI, and releasing grouping corresponding to a second plurality of devices identified according to a context and displaying a plurality of GUIs corresponding to the second plurality of devices identified.

20. The medium of claim 19,
wherein the displaying comprises:
group the plurality of GUIs and control the display to display the group GUI based on a number of devices of the category located in a room being greater than or equal to a predetermined number, and
display a GUI corresponding to the at least one device belonging to the category based on the number of the devices of the category located in the room being smaller than the predetermined number.
